(19) United States
(12) Patent Application Publication
(10) Pub. No.: US 2019/0281666 A1
(43) Pub. Date: Sep. 12, 2019

(54) FLEXIBLE, STRETCHABLE EPIDERMAL HEATER WITH ON-SITE TEMPERATURE FEEDBACK CONTROL

(71) Applicant: BOARD OF REGENTS, THE UNIVERSITY OF TEXAS SYSTEM, Austin, TX (US)

(72) Inventors: Nanshu LU, Austin, TX (US); Kenneth DILLER, Elgin, TX (US); Andrew STIER, Austin, TX (US); Andrew MARK, Austin, TX (US)

(21) Appl. No.: 16/347,906

(22) PCT Filed: Nov. 7, 2017
(86) PCT No.: PCT/US2017/060328

§ 371 Date: May 7, 2019

Related U.S. Application Data
(60) Provisional application No. 62/418,477, filed on Nov. 7, 2016.

(51) Int. Cl. H05B 3/34; H05B 1/02; H05B 3/12

(52) U.S. Cl. CPC H05B 3/342; H05B 1/0272; H05B 2203/036; H05B 2214/04; H05B 2203/003; H05B 3/12

(57) ABSTRACT

Described are systems and methods of warming a patient using a flexible, stretchable resistive heating element, a temperature detection device, a power supply, and a controller.

### CROSS REFERENCE TO RELATED APPLICATION

This application claims priority to and benefit of U.S. Provisional Patent Application No. 62/418,477 filed Nov. 7, 2016, which is fully incorporated by reference and made a part hereof.

### GOVERNMENT SUPPORT CLAUSE

This invention was made with government support under Grant no. N00014-16-1-2044 awarded by the Office of Naval Research and Grant no. R01 EB015522 awarded by the National Institutes of Health. The government has certain rights in the invention.

### TECHNICAL FIELD

Aspects of the disclosure relate generally to an improvement in technology for warming tissue of a person or an animal. Specifically, aspects of the disclosure describe a stretchable epidermal heater with on-site temperature feedback control.

### BACKGROUND

Wearable tissue heaters can play many important roles in the medical field.

They may be used for heat therapy, perioperative warming, and controlled transdermal drug delivery, among other applications. State-of-the-art heaters are too bulky, rigid, or difficult to control to be able to maintain long-term wearability and safety.

Up to now, tissue warming has generally been accomplished by circulating a heated fluid (e.g., air, water, etc.) around portions of a patient's body. However, the need to contain the fluid and to prevent heat loss until the area where heat transfer is desired has complicated these systems and limited their design. Further, it may take a substantial amount of time to warm the fluid or cool it, if needed.

Other existing warming systems may be solid state based using resistive wires as a means to generate heat locally e.g., blankets. This technology, although effective, can be unsafe since the technology produces a constant output regardless of the surroundings, environment or application. Additionally, if the resistive wire circuit breaks it could cause an unintended thermal spike resulting in thermal “run-away” creating a risk of burns to the subject.

Recently, there has been progress in the development of stretchable heaters that may be attached directly to the skin surface, but they often use expensive materials or processes and take significant time to fabricate. Moreover, most of them lack continuously active on-site temperature feedback control, which is critical for accommodating the dynamic temperatures required for most medical applications.

Therefore, systems and methods are desired that overcome challenges in the art, some of which are described above.

### SUMMARY

Disclosed and described herein is a cost-effective, large area, ultra-thin and ultra-soft epidermal heater that has autonomous on-site (e.g., proportional-integral-derivative (PID) temperature control. Embodiments of the device comprises a stretchable heater and a stretchable temperature detector on a soft medical tape as fabricated using the cost and time effective “cut-and-paste” method. It can be noninvasively laminated onto human skin and can follow skin deformation during flexure without imposing any constraint.

In one aspect, a method of warming a patient is disclosed. The method comprises placing one or more flexible, stretchable heating elements in close proximity to a patient's skin; applying a first voltage to at least one of the one or more flexible, stretchable heating elements; monitoring a temperature of the one of the one or more flexible, stretchable heating elements while the first voltage is being applied; and regulating voltage applied to the one of the one or more flexible, stretchable heating elements as the monitored temperature of the one of the one or more flexible, stretchable heating elements approaches a desired temperature.

Another aspect described herein comprises a system for warming a patient. One embodiment of the system comprises a regulated power supply; a controller, wherein the regulated power supply is in communication with and controlled by the controller; one or more flexible, stretchable resistive heating elements (RHEs), wherein the one or more flexible, stretchable RHEs are connected to the power supply; and one or more temperature measurement devices in communication with the controller through a feedback loop, wherein a first voltage is applied by the regulated power supply to at least one of the one or more flexible, stretchable RHEs, a temperature of the one of the one or more flexible, stretchable RHEs is monitored by the one or more temperature measurement devices in communication with the controller through a feedback loop while the first voltage is being applied, and voltage applied to the one of the one or more flexible, stretchable RHEs is regulated by the regulated power supply in communication with the controller as the monitored temperature of the one of the one or more flexible, stretchable RHEs approaches a desired temperature.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1A illustrates a method of fabricating a programmable epidermal heating device;

FIG. 1B is a photograph of an exemplary complete programmable epidermal heating device on transparent Tegaderm™ (3M, St. Paul, Minn.) with a blue background;

FIGS. 1C and 1D are photographs that show exemplary snap button connectors used to connect lead wires to both the RHE and the RTD;

FIGS. 2A and 2B are photographs that show an exemplary flexible, stretchable epidermal heating device attached to the skin, illustrating its ability to conform to the skin and deform with the skin without mechanical resistance;

FIGS. 2C and 2D are infrared images that show an exemplary flexible, stretchable epidermal heating device supplied an even amount of heat over the palm around the target temperature of 40° C. and that there was minimum change in temperature during severe skin deformation such as hand clenching;

FIG. 3A is a photograph of a set-up for calibrating an RTD of an exemplary flexible, stretchable epidermal heating device;

FIG. 3B is a graph illustrating the RTD under calibration in FIG. 3A exhibited the expected linear relationship between resistance and temperature with a temperature coefficient of resistance (TCR) of 0.0025° C.⁻¹; \

FIG. 3C is an electrical schematic of the calibration set-up as depicted in FIG. 3A;

FIG. 3D shows an IR image of an exemplary flexible, stretchable epidermal heating device on a human palm illustrating that the temperature across the heater is fairly uniform over an area of 60 mm×45 mm;

FIG. 3E is a plot of temperature versus distance of the heater of FIG. 3D;

FIG. 3F illustrates synchronously measured temperature and resistance vs. time curves, which show excellent alignment;

FIG. 3G is a graph that plots relative resistance change vs. temperature change having a linear fit with a TCR of 0.0020° C.⁻¹;

FIGS. 4A and 4B display the top and 3-D cross-sectional views of the temperature distribution within the skin under equilibrium while the heater was on;

FIG. 4C plots temperature distributions along the three lines drawn on the left frame of FIG. 4A (blue=top, red=middle, and green=bottom) where the blue, red and green curves of FIG. 4C correspond to the blue, red and green lines, respectively;

FIG. 4D illustrates a simulated equilibrium temperature distribution in the skin along the depth direction (as indicated by the black arrow in FIG. 4B);

FIG. 5A illustrates a real time PID feedback control;

FIG. 5B illustrates an embodiment of the device was able to maintain a constant temperature of 38.5° C. for over 30 minutes on human skin until the heater was completely turned off;

FIG. 5C shows results of a test to determine if an embodiment of the device could self-adjust when set temperature changes with multiple set temperatures (37° C., 38.5° C., 40° C.) while the voltage supply was kept constant at 6.2 V;

FIG. 6A plots the actual skin temperature measured by the RTD vs. time and the labels are again voltage supply and set temperature and at each set temperature, the steady state duty cycle was recorded;

FIG. 6B shows the duty cycle vs. time plot;

FIG. 6C shows that plotting power density vs. the corresponding temperature as red markers, a linear relation can be fitted;

FIGS. 6D-6F illustrate the results of replication of the entire experiment of FIGS. 6A-6C, but with insulation over the heater;

FIG. 7 shows a flowchart of an embodiment of a method of warming a patient; and

FIG. 8 is a block diagram illustrating an exemplary operating environment for performing the disclosed methods.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices. Furthermore, all or portions of aspects of the disclosed can be implemented using cloud-based processing and storage systems and capabilities.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

There exists a need for soft, stretchable electronic heating devices which can conform to human skin unobstructively and stay attached during long term use. Such devices can serve a variety of applications in the medical field. As some examples, heat is commonly used in physical therapy following exercise-induced delayed onset muscle soreness (DOMS). Heating injured joints can induce thermal expansion of the collagen tissue and thus reduce pain and stiffness. When hypothermia occurs due to anesthesia, applying heat to the palms and soles of a patient with distended blood vessels can re-warm the body's core temperature. Applying heat over a skin surface can accelerate the diffusion of chemicals transdermally from a drug patch.

Conventional heaters used to treat muscle pain or joint injuries include electric heat packs and heat wraps. Heat packs do not have very controllable temperature and are heavy and bulky. Heat wraps are easier to control but are also heavy, and their rigidity makes it difficult for them to be worn seamlessly. These products' inability to conform well to skin make them less comfortable and also present a more severe problem—lack of uniform and consistent adhesion to the skin surface could lead to air gaps which cause hotspots. These hotspots could burn the skin if the heater is operated near the safety threshold of 43° C. This can severely limit the range and thus the effectiveness of the conventional heaters.

One heating method that can safely heat the body at temperatures close to 43° C., and the current gold standard for preventing the hypothermia caused by anesthesia, is forced air warming. Forced air warming heats air and pumps it into blankets covering large portions of the patient. While effective at raising the core body temperature, forced air warming has some disadvantages including bulkiness, obstructiveness to surgeries, and high cost.

Recently there has been an expansion of the development of stretchable electronics. Methods that have been used to produce these type of electronics include embedding carbon nanotubes (CNTs) in elastomers, depositing silver (Ag) nanoparticles in polyurethane, chemically bonding Ag flakes to CNTs, combining Ag nanoparticles with elastomeric fibers, constructing stretchable gold (Au) electrodes from multi-layers of Au nanosheets, patterning metal thin films into serpentine or fractal shapes to minimize their strain during stretching, and the like. Patterning metal thin films into serpentine or fractal shapes to minimize their strain during stretching enabled the creation of epidermal electronics, which are ultrathin, ultrasoft electronics, physiological sensors, electrical and thermal stimulators that can adhere and conform to skin surfaces and bend and stretch without breaking, detaching, or imposing any mechanical constraint to the skin.

With the development of stretchable electronics, stretchable patch heaters have emerged in recent years. Examples include joule heating devices fabricated from soft Ag nanowire composites, stretchable Au serpentines, and the like. Using a stretchable and conformable heater could solve the major disadvantages of conventional solid heaters. However, the existing stretchable heaters involve expensive nanomaterials or time consuming procedures to produce. Moreover, most of them have no method of acquiring temperature feedback from the heater as they are not equipped with any temperature sensors. As a result, none of the reported stretchable heaters except for one use temperature feedback to autonomously control the temperature of the heater. The one with temperature feedback only has it as a safety switch which turns the heater off if it gets too hot—aside from that, the temperature feedback is not used to actively control the heat of the heater. Without the use of effective temperature feedback, past stretchable heating devices have relied on the relationship between voltage and heat generated in order to maintain the heater at a desired temperature. However, conditions vary from person to person, and it is inaccurate to assume a consistent relationship between voltage and temperature if you wish to apply the same heater to multiple subjects. For example, changes in blood flow can cause changes in epidermal skin temperature.

The recently developed “cut-and-paste” method (see Yang, S. et al. ‘Cut-and-Paste’ Manufacture of Multiparametric Epidermal Sensor Systems. Adv. Mater. 27, 6423-6430 (2015), which is fully incorporated by reference), in which stretchable patterns are cut out of ultrathin metal-polymer laminates and pasted to an adhesive substrate, allows for cheaper, quicker, and greener fabrication of epidermal sensors. This method also allows for easy integration of independent heaters and resistance temperature detectors (RTDs) on the same substrate. Using this method, described herein is an inexpensive, easy to fabricate, and power-efficient programmable epidermal heating device. One of the embodiments of this device comprises a stretchable resistive heating element (RHE) of serpentine-shaped aluminum (Al) ribbons and a stretchable RTD of serpentine-shaped Au ribbons. Included with this device is a customized proportional-integral-derivative (PID) control software that uses real time temperature feedback to control the heater and can maintain it at a target temperature over a large area of skin for extended periods of time.

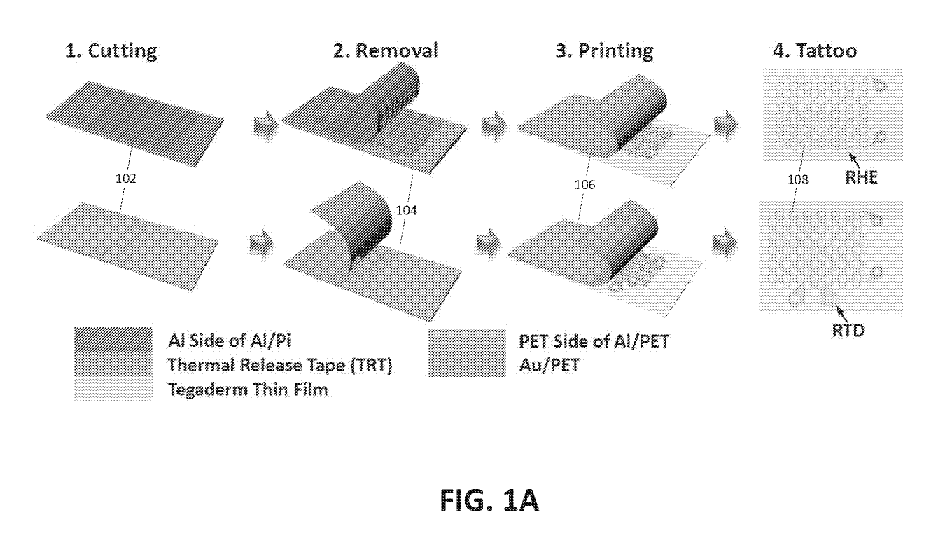

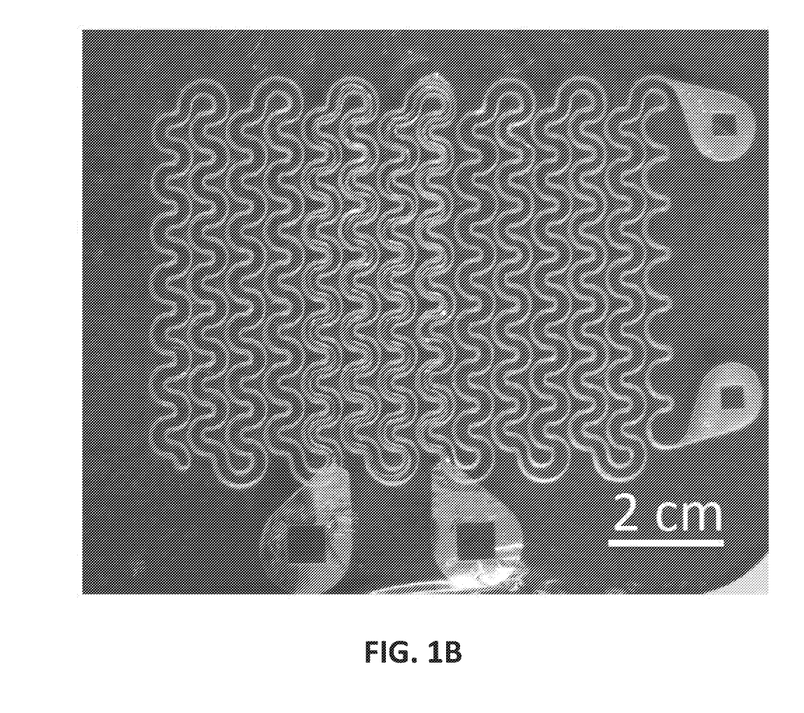

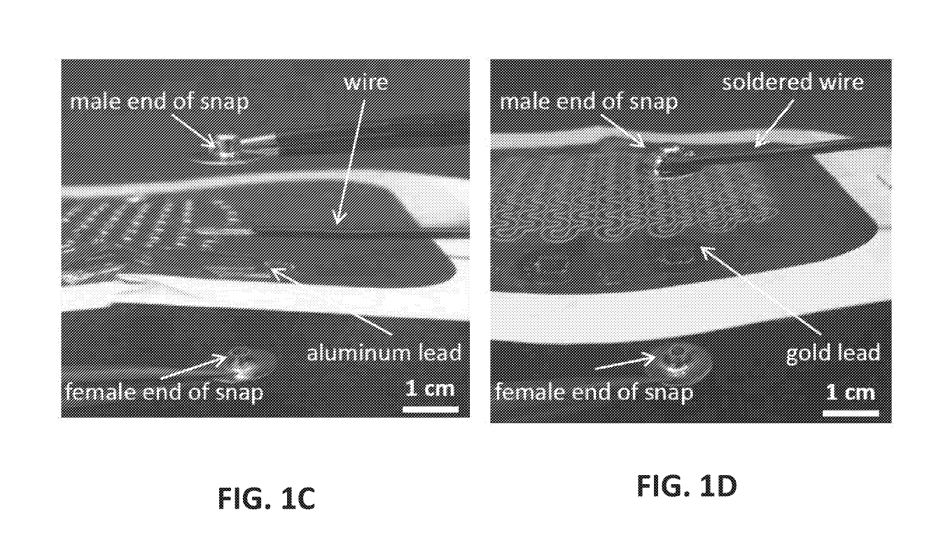

FIG. 1A illustrates a method of fabricating a programmable epidermal heating device. The upper row of FIG. 1A illustrates cut-and-paste fabrication for stretchable resistive heating element (RHE) and the lower row of FIG. 1 illustrates the fabrication steps for a resistance temperature detector (RTD). FIG. 1B is a photograph of an exemplary complete programmable epidermal heating device on transparent Tegaderm™ (3M, St. Paul, Minn.) with a blue background. In this embodiment, 9 μm thick Al on 13 μm thick blue PET substrate forms the RHE while 100 nm Au/10 nm Cr on 13 μm transparent PET forms the resistance temperature detector.

As depicted in the first row of FIG. 1A, the process comprises 102 placing a blanket 7 μm/13 μm Al/PET bilayer laminate (NEPTCO Inc., Pawtucket, R.I.) smoothly on a thermal release tape (TRT), (Semiconductor Equipment Corp., Moorpark, Calif. USA) with Al facing up. A Silhouette mechanical cutter plotter (Silhouette America, Inc., Lindon, Utah) was programmed to cut the designed seams on the bilayer within 3 minutes. At 104, excessive Al/PET was removed once the TRT was heated, and the remaining Al/PET ribbon was printed 106 on Tegaderm™ tape with the Al side facing the Tegaderm™ and the bluish PET side facing outward. The 13-μm thick PET layer allows for increased mechanical integrity and electrical insulation. The same process was repeated to cut and paste the stretchable RTD ribbon, which was made out of 100 nm/15 nm/13 μm Au/Cr/PET laminate, with the PET facing the Tegaderm™ and the Au facing outward, as illustrated by the second row of FIG. 1A. This arrangement resulted in two layers of insulation between the Al RHE and the Au RTD at locations where the two intersected. Both the RHE and the RTD were cut into serpentine ribbons, which contributes to the stretchability and softness of the device. Specifically, the stretchability and softness of these serpentine ribbons can be maximized by fabricating their width to be as narrow as possible. Due to the resolution of the Silhouette cutter, all ribbon width were fixed to be 400 μm. Although the resolution is far from photolithographic patterning technologies, the cost of time, materials, and facilities is significantly reduced using the freeform cut-and-paste process because it does not require any chemicals, photomasks or cleanroom facilities. Moreover, while the photolithographic process is limited to wafer scale, the patterning area of the cutter plotter can be as large as 12 inches wide and several feet long.

At 108, an ultrathin, ultrasoft double-sided tattoo adhesive was laid on top of the RHE and the RTD, providing a final layer of electrical insulation as well as increased adhesion between the skin and the patch. Snap button connectors were used to connect lead wires to both the RHE and the RTD, as shown in the photographs of FIGS. 1C and 1D.

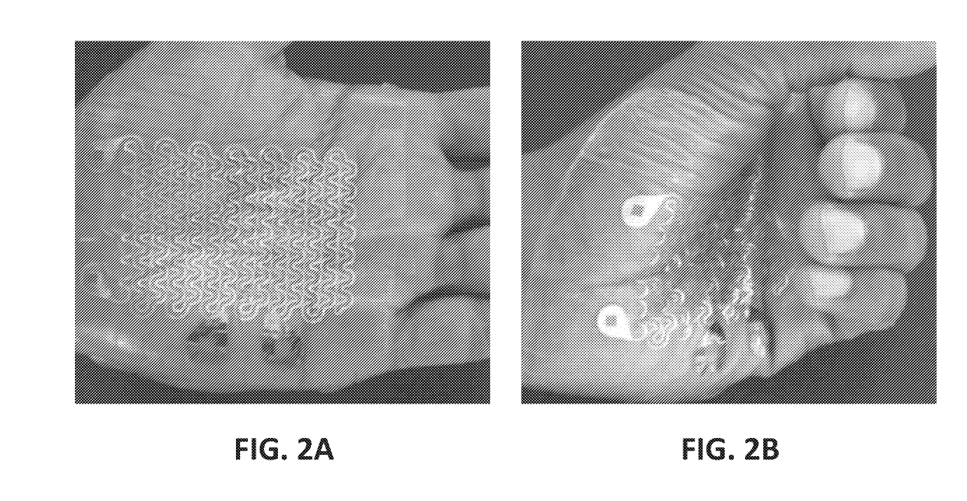

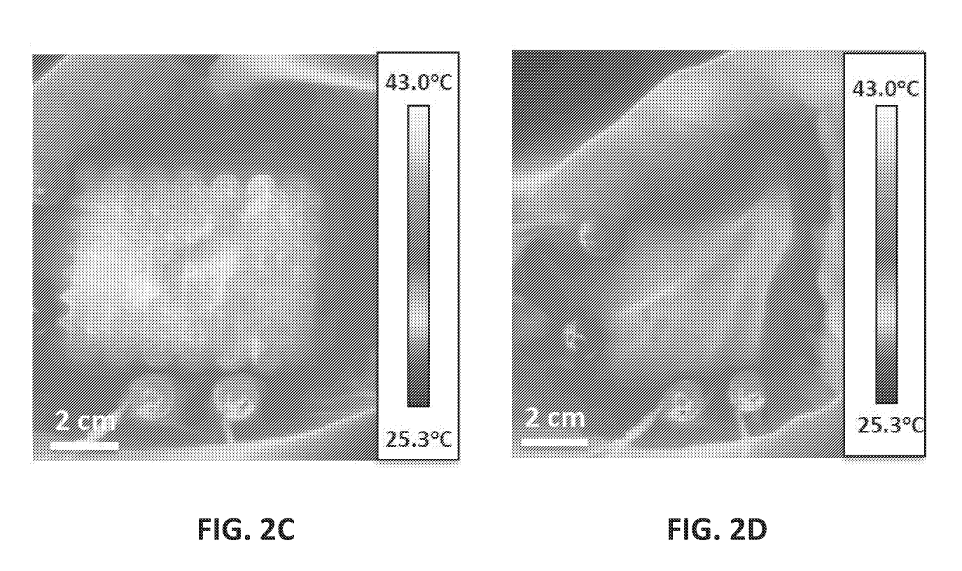

When attached to the skin, this exemplary device conforms to the skin and deforms with the skin without mechanical resistance, as evidenced by FIGS. 2A and 2B. When a DC voltage of 5.1 V was applied across the Al RHE, it supplied an even amount of heat over the palm around the target temperature of 40° C. There was minimum change in temperature during severe skin deformation such as hand clenching, as demonstrated by FIGS. 2C and 2D, which were taken by an infrared (IR) camera (FLIR T620).

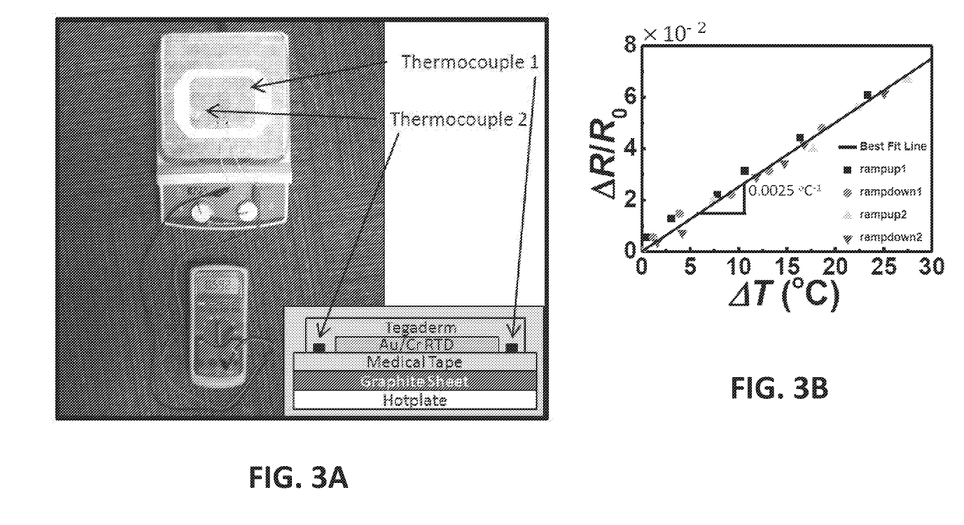

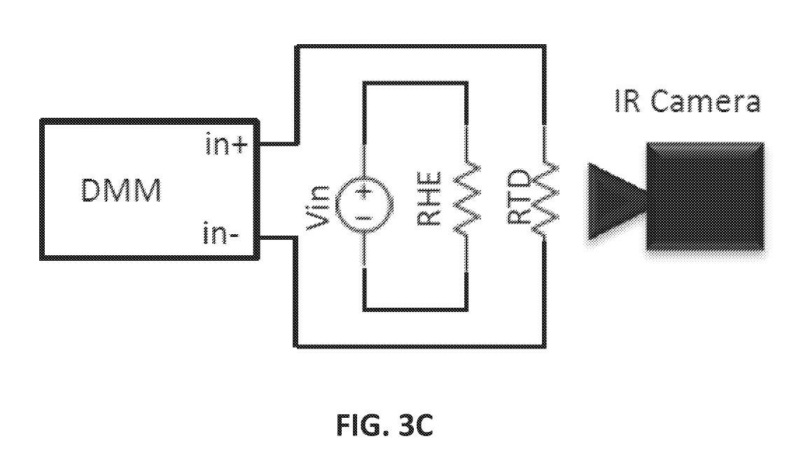

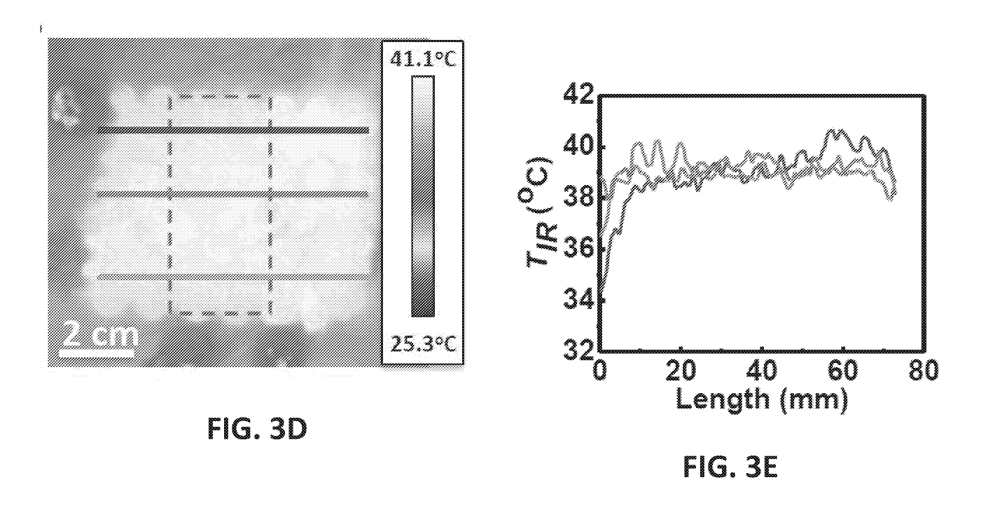

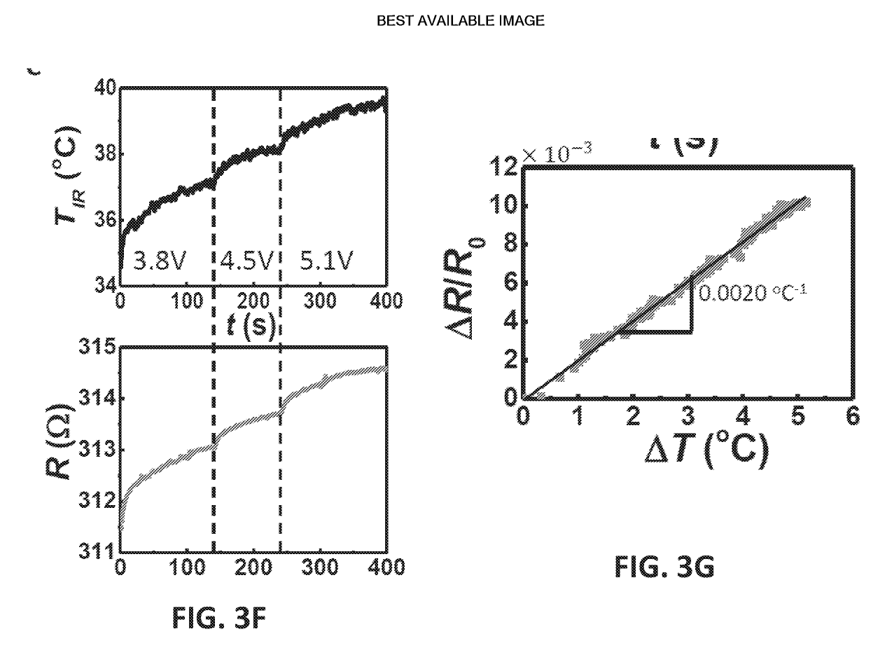

To calibrate the RTD, referring to the photograph of FIG. 3A, it was placed on an insulated hot plate, and its resistance was compared against the temperature readings of two custom made type T thermocouples. As shown in FIG. 3B, the RTD exhibited the expected linear relationship between resistance and temperature with a temperature coefficient of resistance (TCR) of 0.0025° C.⁻¹. To obtain the TCR under service condition, calibration of the RTD was also conducted on skin together with the RHE, and an IR camera was used for temperature measurement. In this set-up, the heat comes from the RHE instead of the hotplate, and the RTD is in intimate contact with the actual heat sink—the skin. Because of these differences, it was hypothesized that the TCR would be different from that measured on the hotplate. A schematic of the calibration set-up is depicted in (FIG. 3C). The RHE was linked to a DC voltage supply (Mastech Linear Power Supply HY1803D) while the RTD was connected to a digital multimeter (DMM, NI Elvis II). Resistance readings were logged using the DMM and LabVIEW 2014. The device was covered with a fine layer of Johnson's Baby Powder to control its thermal radiation emissive properties. The DC voltage supply was set to different voltages, and the temperature and resistance of the RTD were measured simultaneously using the IR camera and the DMM, respectively. Temperature readings from the IR camera were logged using FLIR Tools +.

For safety purposes, the RHE-RTD calibration was first carried out on a glass slide, which has thermal properties similar to those of human skin. The TCR was measured to be 0.0022° C., which is slightly lower than that measured by the hotplate calibration.

After ensuring the RHE behavior, a similar RHE-RTD calibration was performed on human skin. FIG. 3D shows the IR image of the heater on human palm. It is evident that the temperature across the heater is fairly uniform over an area of 60 mm×45 mm. The dotted black box indicates where the RTD resides. The IR temperature for the RTD calibration used in FIGS. 3F and 3G were obtained by averaging the temperature within this boxed area. It is clear in FIG. 3D that the existence of the RTD does not affect the RHE or the temperature distribution. The three solid horizontal lines drawn across the heater mark the locations where the temperature is plotted as a function of distance along the lines in FIG. 3E. Within the area covered by the RHE, temperature variation is between 38° C. and 40° C. To continuously increase the temperature, the DC voltage was set to 3 increasing values: 3.8 V, 4.5 V, and 5.1 V. Synchronously measured temperature and resistance vs. time curves are provided in FIG. 3F, which shows excellent alignment. Plotting relative resistance change vs. temperature change in FIG. 3G, a linear fit with a TCR of 0.0020° C.⁻¹ can be obtained. As expected, this is lower than the TCR found with the hotplate calibration (0.0025° C.-1) or the glass substrate calibration (0.0022° C.-1) due to the fact that the RTD is well conformed to human skin, beneath which blood flow can help mitigate the heat.

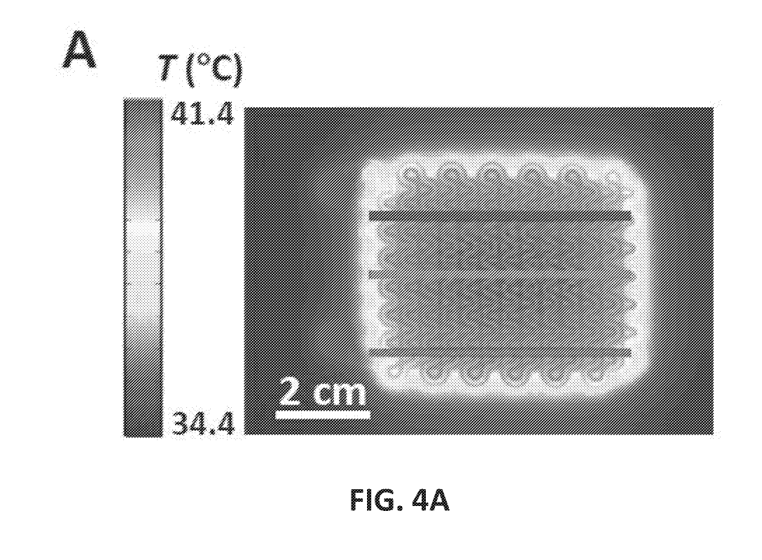

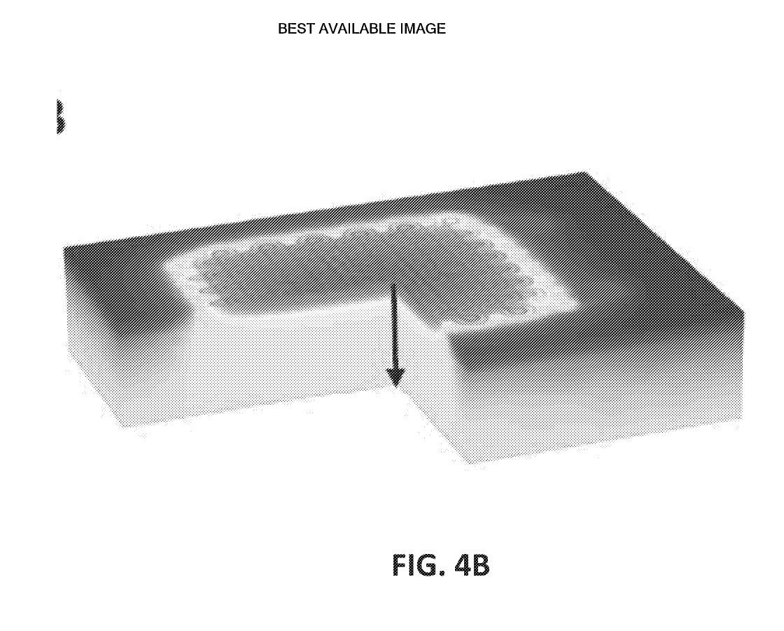

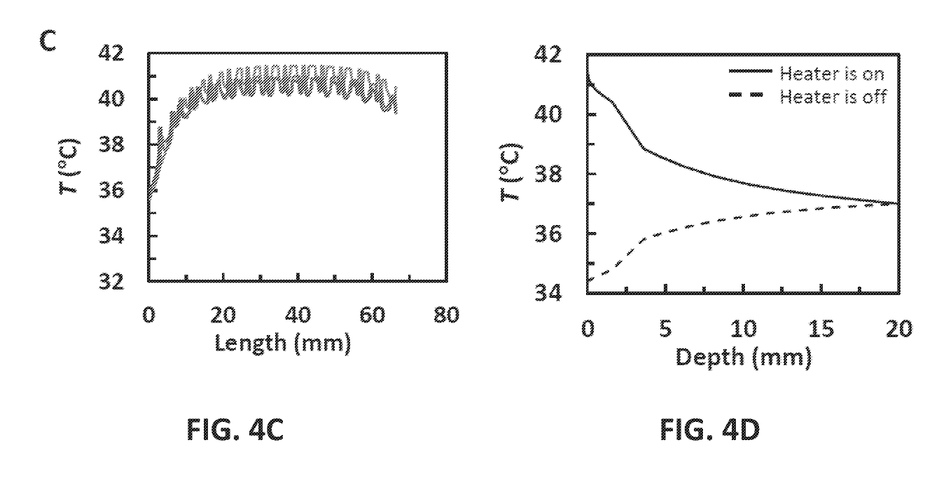

To verify the experimental findings, a COMSOL simulation of the device heating human skin was run. The skin was modeled as a multilayer substrate made up of epidermis (0.1 mm thick), papillary dermis (0.7 mm thick), reticular dermis (0.8 mm thick), fat (2 mm thick) and muscle (16.4 mm thick), each with different thermophysical properties taken from literature. Ambient radiation from the RHE and convective cooling between the RHE and the environment were taken into consideration. With the environment temperature set at 15° C. and the core temperature set at 37° C., the skin surface temperature stabilized at 34.4° C. when the heater was off. The effective electrical conductivity of the RHE was calibrated by setting the maximum temperature to be 41.4° C. when the applied voltage was 5.1V. Using a Joule heating model for the RHE and a heat transfer model for the other components of the device and the skin, the modeled temperature distribution across the skin was found under transient and equilibrium states. FIGS. 4A and 4B display the top and 3-D cross-sectional views of the temperature distribution within the skin under equilibrium while the heater was on. FIG. 4C plots temperature distributions along the three lines drawn on the left frame of FIG. 4A (blue=top, red=middle, and green=bottom) where the blue, red and green curves of FIG. 4C correspond to the blue, red and green lines, respectively. The close agreement between FIG. 3E and FIG. 4C validates the COMSOL model and gives more credit to the simulated equilibrium temperature distribution in the skin along the depth direction (as indicated by the black arrow in FIG. 4B), as plotted in FIG. 4D. When the heater is off (dashed curve), skin surface temperature is 34.4° C. As the depth increases, the curve approaches the core temperature of 37° C. When the heater is on (solid curve), skin surface is heated to 41.4° C. The temperature gradually decays to 37° C. as we go deep into the skin. The slight kinks in the curves are due to the change of the thermophysical properties of the different layers of human skin.

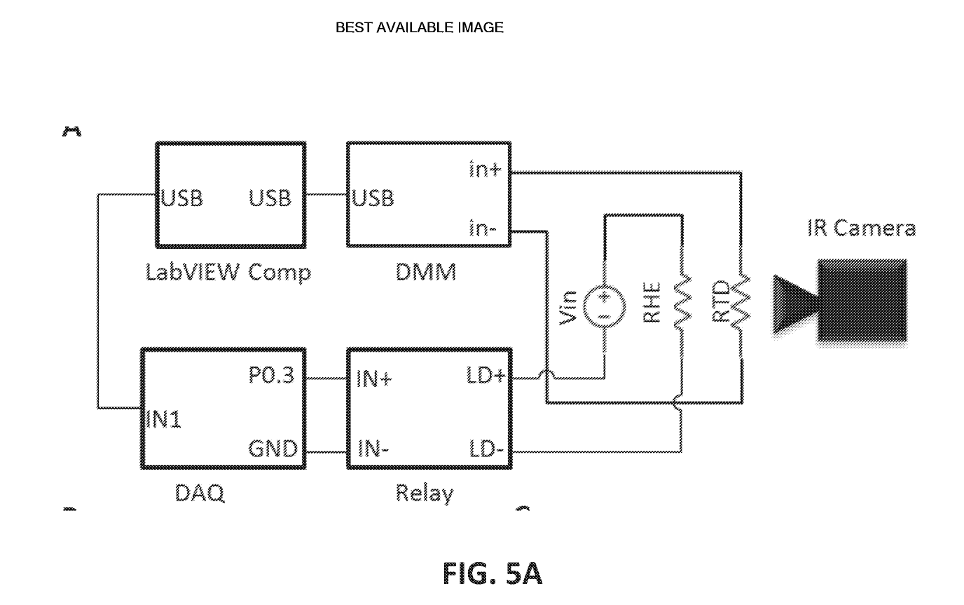

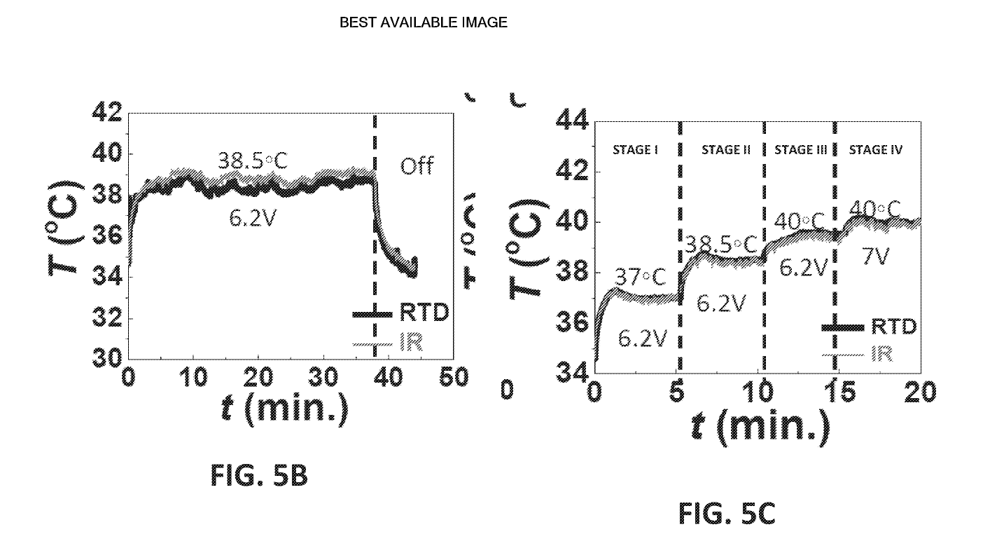

After calibrating the RTD and characterizing the RHE, a real time PID feedback control was developed as illustrated by the diagram in FIG. 5A. The DC power to the RHE was routed through an Omron DC-DC relay (G3CN) which was controlled by a computer using an output DAQ (NI USB-6009). The computer ran a LabVIEW program which controlled the temperature of the RHE using pulse width modulation (PWM). The RTD was connected to the DMM of an NI Elvis II, which measures the RTD's resistance and sends the readings to the LabVIEW program in real time. The LabVIEW program converted the resistance readings into temperature using the following equation:

$$T = {T}_{0} + \frac{Δ R}{0.002 {R}_{0}} \qquad ( 1 )$$

where the initial resistance R₀ was measured at the room temperature T₀, and the coefficient 0.0020° C.⁻¹ was the TCR obtained from the calibration on human skin in FIG. 3G. The PID program then used the real time temperature feedback, along with a desired temperature set point, to determine how to control the relay and thereby the PWM of the RHE. This allowed the program to keep the heater at a set temperature or to adjust to a new temperature when demanded.

First, to test if the device could effectively maintain a target temperature the DC voltage supply was set to 6.2 V, and the temperature was set to 38.5° C. The device was able to maintain a constant temperature of 38.5° C. for over 30 minutes on human skin until the heater was completely turned off to finish the experiment as shown in FIG. 5B. The temperature readings of the RTD (black curve) was also verified by the IR camera results (red curve).

To test if the device could self-adjust when set temperature changes, an experiment was conducted with multiple set temperatures (37° C., 38.5° C., 40° C.) while the voltage supply was kept constant at 6.2 V (see FIG. 5C). For the first two temperatures (Stages I and II), the device was able to reach the set temperatures and to maintain them at a steady state. In switching between these temperatures, no changes were made except changing set point in the LabVIEW program. When the voltage was kept at 6.2 V and the target temperature was set to 40° C., which is marked as Stage III, the actual skin surface temperature was not able to reach 40° C. This indicates insufficient power supply even when the duty cycle of the PWM reached 100%. We therefore increased the voltage to 7 V, and the skin surface was then successfully heated to 40° C., as in Stage IV. Again, the temperature measured by the RTD (black) and the IR camera (red) are well matched. This experiment demonstrates that when given a sufficient voltage supply, the stretchable epidermal heater can automatically reach, maintain, and change between desired temperatures without any manual adjustment of the voltage.

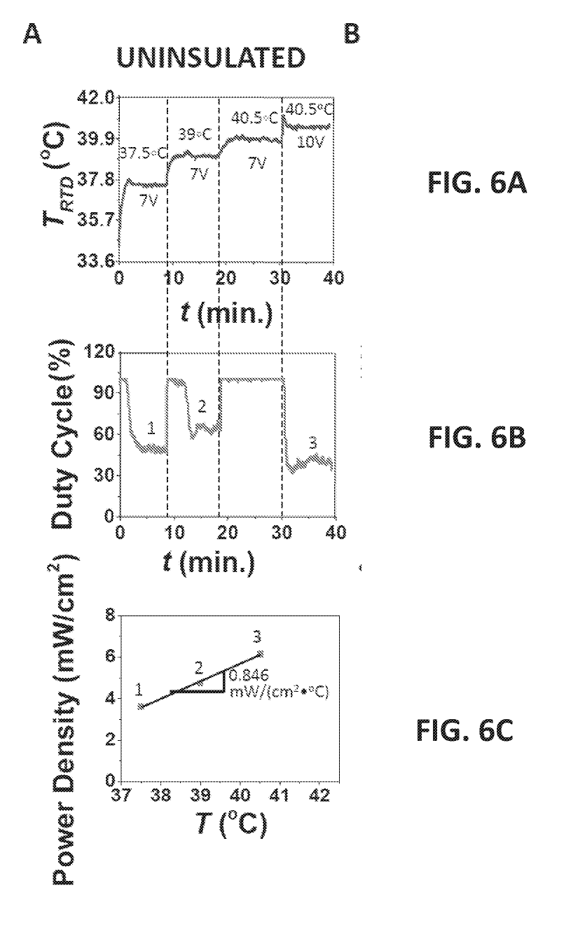

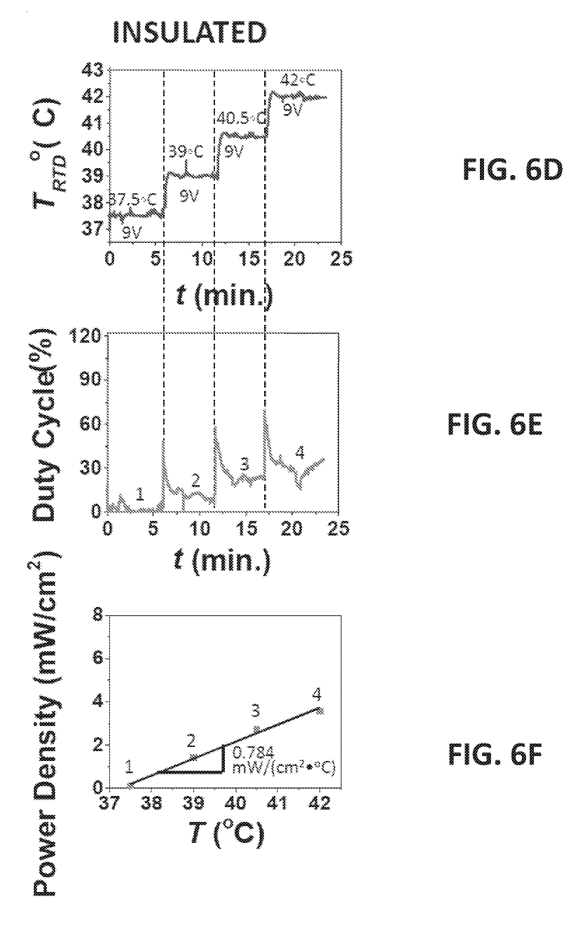

To reveal the power consumption of the epidermal heater, the duty cycles at different set temperatures were investigated. The device was placed on human palm with PID control. FIG. 6A plots the actual skin temperature measured by the RTD vs. time and the labels are again voltage supply and set temperature. At each set temperature, the steady state duty cycle was recorded. FIG. 6B shows the duty cycle vs. time plot. The numbers mark the plateaus where the device was considered to have reached steady state. The duty cycle for each set temperature was calculated as the average of the duty cycle readings at these plateaus. The following equation was then used for power calculation:

$$P = \frac{D}{100 \%} ⋆ \frac{{V}^{2}}{R} \qquad ( 2 )$$

where D stands for the duty cycle, V is the voltage supplied to the RHE, and R is the resistance of the RHE.

If power density is defined to be the power delivered to the skin per unit area of the RHE, power density can be calculated through:

Power Density=P/A (3)

where A represents the total area of the heater, which is 38.7 cm² for the described RHE. Plotting power density vs. the corresponding temperature as red markers in FIG. 6C, a linear relation can be fitted. The slope of this linear curve is defined as the specific power flow (SPF), which represents power density normalized to the applied thermal driving potential, i.e. temperature difference. The SPF of the exemplary stretchable epidermal heater is estimated to be 0.846 mW/(cm²·° C.), which means that to heat up a 1 cm² area of this specific human palm by 1° C. would consume a power of 0.846 mW.

Considering convection and radiation between the heater and the ambient environment, it is inaccurate to assume that all the heat generated by the RHE completely goes into the skin. To obtain a more accurate estimation of the specific power flow into the skin, the entire experiment of FIGS. 6A-6C was repeated in FIGS. 6D-6F, but with insulation over the heater. A 1.5 in. thick layer of foam, which is a well-known heat insulator, was taken from a delivery package and applied over the heater on the palm to minimize heat loss into the environment. With this heat insulating foam, the SPF was found to be 0.784 mW/(cm2·° C.) as given in FIG. 6F, which is 7.33% lower compared with that of the exposed heater (0.846 mW/(cm²·° C.)). This result indicates that about 7.33% of the heat generated by the RHE was lost to the environment when the RHE was exposed to air.

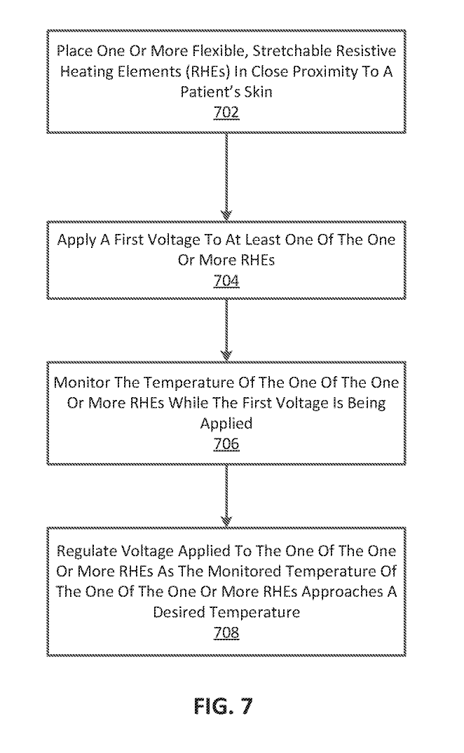

FIG. 7 shows a flowchart of an embodiment of a method of warming a patient. The illustrated method comprises 702 placing one or more flexible, stretchable heating elements in close proximity to a patient's skin, each flexible, stretchable heating element having an associated temperature detection device. In one aspect, placing the one or more flexible, stretchable heating elements heating elements in close proximity to the patient's skin may comprise adhesively affixing the one or more flexible, stretchable heating elements to the patient's skin. In one aspect, the one or more pads may be affixed to each of the patient's feet and/or each of the patient's hands and/or to the patient's neck. The flexible, stretchable heating elements can conform/deform to the curvature of the applied areas of the body (i.e. hands and feet) resulting in better surface area coverage, intimacy of contact with the skin, and thus superior heat transfer into the body.

At 704, a first voltage is applied to at least one of the one or more flexible, stretchable heating elements. At 706, the temperature of the one of the one or more flexible, stretchable heating elements is monitored while the first voltage is being applied. Monitoring the temperature of the one of the one or more flexible, stretchable heating elements while the first voltage is being applied each pad may comprise monitoring the temperature between the flexible, stretchable heating elements and the patient's skin using a feedback loop in communication with a controller. For example, the temperature may be monitored using a thermistor, thermocouple, resistance temperature device (RTD) in communication with a controller. In other aspects, the temperature of the patient, either internally or externally, may be used to control the voltage applied to the flexible, stretchable heating elements.

At 708, voltage applied to the one of the one or more flexible, stretchable heating elements is regulated as the monitored temperature of the one of the one or more flexible, stretchable heating elements approaches the desired temperature. Conversely, the voltage applied to the one of the one or more flexible, stretchable heating elements may be regulated by increasing the voltage, thus driving the temperature toward the desired temperature even more quickly. The applied voltage is regulated by a controller based on the temperature as monitored by temperature measurement devices that are in communication with the controller through a feedback loop.

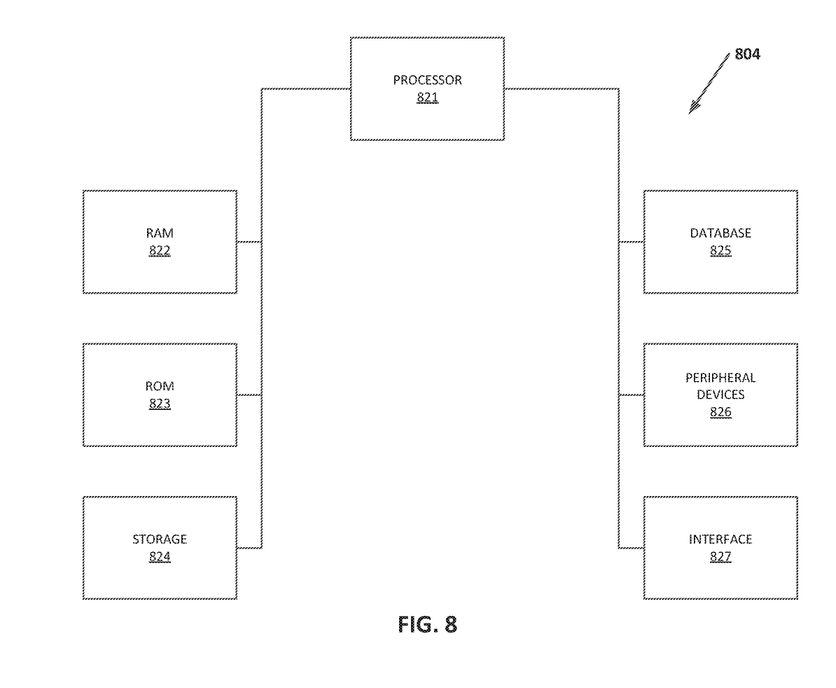

The system has been described above as comprised of units. One skilled in the art will appreciate that this is a functional description and that the respective functions can be performed by software, hardware, or a combination of software and hardware. A unit can be software, hardware, or a combination of software and hardware. The units can comprise software in combination with hardware to perform a method for warming of a patient, as illustrated in FIG. 8 and described below. In one exemplary aspect, the units can comprise a controller 804 as illustrated in FIG. 8, described below.

FIG. 8 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise network PCs, minicomputers, mainframe computers, controllers, smartphones, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

FIG. 8 illustrates an exemplary controller 804 that can be used for controlling aspects of a system for warming of a patient. As used herein, “controller” may include a plurality of controllers. The controllers may include one or more hardware components such as, for example, a processor 821, a random access memory (RAM) module 822, a read-only memory (ROM) module 823, a storage 824, a database 825, one or more peripheral devices 826, and an interface 827. Alternatively and/or additionally, controller 804 may include one or more software components such as, for example, a computer-readable medium including computer executable instructions for performing a method associated with the exemplary embodiments. It is contemplated that one or more of the hardware components listed above may be implemented using software. For example, storage 824 may include a software partition associated with one or more other hardware components. It is understood that the components listed above are exemplary only and not intended to be limiting.

Processor 821 may include one or more processors, each configured to execute instructions and process data to perform one or more functions associated with for controlling aspects of a system for warming of a patient. Processor 821 may be communicatively coupled to RAM 822, ROM 823, storage 824, database 825, peripheral devices 826, and interface 827. Processor 821 may be configured to execute sequences of computer program instructions to perform various processes. The computer program instructions may be loaded into RAM 822 for execution by processor 821.

RAM 822 and ROM 823 may each include one or more devices for storing information associated with operation of processor 821. For example, ROM 823 may include a memory device configured to access and store information associated with controller 804, including information for identifying, initializing, and monitoring the operation of one or more components and subsystems. RAM 822 may include a memory device for storing data associated with one or more operations of processor 821. For example, ROM 823 may load instructions into RAM 822 for execution by processor 821.

Storage 824 may include any type of mass storage device configured to store information that processor 821 may need to perform processes consistent with the disclosed embodiments. For example, storage 824 may include one or more magnetic and/or optical disk devices, such as hard drives, CD-ROMs, DVD-ROMs, or any other type of mass media device.

Database 825 may include one or more software and/or hardware components that cooperate to store, organize, sort, filter, and/or arrange data used by controller 804 and/or processor 821. For example, database 825 may store historical data related to the temperature of the flexible, stretchable heating elements approaching the desired temperature, the rate of approach, the differential for reducing and/or regulating voltage applied to the flexible, stretchable heating elements, and the like. Additionally and/or optionally, database 825 may store instructions and/or information to perform a method for warming of a patient, comprising. It is contemplated that database 825 may store additional and/or different information than that listed above.

Peripheral devices 826 may include one or more components configured to communicate information with a user associated with controller 804. For example, peripheral devices 826 may include a console with an integrated keyboard and mouse to allow a user to enter information about a patient and/or to make temperature settings for the warming of a patient. Peripheral devices 826 may also include a display including a graphical user interface (GUI) for outputting information on a monitor. Peripheral devices 826 may also include devices such as, for example, a printer for printing information associated with controller 804, a user-accessible disk drive (e.g., a USB port, a floppy, CD-ROM, or DVD-ROM drive, etc.) to allow a user to input data stored on a portable media device, a microphone, a speaker system, an image capture device (e.g. camera), or any other suitable type of interface device.

Interface 827 may include one or more components configured to transmit and receive data via a communication network, such as the Internet, Ethernet, a local area network, a wide-area network, a workstation peer-to-peer network, a direct link network, a wireless network, or any other suitable communication platform. For example, interface 827 may include one or more modulators, demodulators, multiplexers, demultiplexers, network communication devices, wireless devices, antennas, modems, and any other type of device configured to enable data communication via a communication network.

### Examples/Results

In one non-limiting example, a stretchable epidermal heater was fabricated for testing purposes. This comprised fabrication of Au/Cr/PET laminate where a 13-μm PET (Goodfellow USA) was taped around a 3 in. long, 1 in. wide, and 1 mm thick glass slide then cleaned with acetone, IPA, and water, and then blown dry with compressed air. 10 nm of chromium and then 100 nm of Au were then thermally evaporated onto the PET. The tape was then removed from the PET, and the PET was unwrapped from the glass slides.

Further comprising the stretchable epidermal heater comprised fabrication of the RHE and RTD. Schematics for the cut-and-paste process are shown in FIG. 1A. To make the RHE, an Al/PET laminate (Neptco Inc.) was rolled onto thermal release tape (TRT, Semiconductor Equipment Corp., USA) with the PET side facing the TRT. The other side of the TRT was adhered on the cutting mat of a Silhouette Cameo electronic cutter plotter, which was then inserted into the machine. A 2D pattern designed in SolidWorks was imported into Silhouette Studios software and carved on the Al/PET laminate. The TRT was removed from the cutting mat and covered by a polymer liner removed from a Tegaderm™ tape (3M). The TRT was then placed on a hotplate for 5 minutes at a temperature of 120° C. to deactivate the adhesive. The liner helped keep the laminate from delaminating from the TRT as it lost adhesion. The TRT was then taken off the hotplate, the liner was removed, and tweezers were used to peel off all of the excess Al/PET from the TRT, leaving only the pattern as designed. The adhesive side of a Tegaderm™ patch was placed onto the pattern to peel it off the TRT. The Al/PET pattern was thus transferred to the Tegaderm™ with the Al side facing the Tegaderm adhesive and the PET side facing outward. The Au/Cr/PET laminate was then put through the same process with the RTD pattern cut into it, and transferred on top of the RHE with the PET side facing the Tegaderm adhesive and the Au side facing outward. The final device is shown in FIG. 1B. Snap buttons sandwiching the lead wires to the device were installed at the terminals of the RTD and RHE as illustrated in FIGS. 1C and 1D.

Testing heating and temperature sensing on human skin involved the subjects washing their hands and drying them thoroughly. Each subject's palm was rubbed with a paper towel to abrade dead skin cells from the surface. The hand was fixed to a custom slanted platform covered with foam taken from a delivery package for thermal insulation with the palm facing outward. The epidermal heater was then applied to the palm and was connected into the circuit shown in FIG. 5A using alligator clips. The epidermal heater was then covered with a fine layer of baby powder to control the thermal radiation emissive properties. An IR camera was positioned on a tripod and aimed at the epidermal heater. The IR camera recording and the LabVIEW controlling and logging program were initiated simultaneously, and then the DC voltage supply for the heater was turned on. Target temperatures were set in LabView as desired for the experiment. The LabVIEW program acquired and logged electrical resistance signals from the RTD on the device and converted these readings to temperature using Equation (1), above, where T₀ is the hand's initial temperature, R₀ is the RTD's initial resistance, and 0.002 is the TCR of the RTD calibrated on the palm. The program also regulated the temperature of the heater by varying the power supply using PWM. Experiments were terminated by turning off the DC voltage supply.

### CONCLUSIONS

A low cost, low power consumption stretchable epidermal heater is described herein and an exemplary heater was fabricated to reliably warm the skin surface to a target temperature. The device combines a stretchable RHE and a stretchable RTD into a single unit through the cost and time effective “cut-and-paste” fabrication method. The device is thin (approximately 60 μm thick) and soft (7.4 MPa modulus) so that it can conform to the complex 3-D surface of palms and can deform and remain attached during hand flexure without perceivable mechanical resistance. The RHE is able to reach set temperatures with relatively even distribution, including during hand movement. The RTD can monitor the real time temperature of the palm accurately, as verified through simultaneous IR measurements. Through PID temperature feedback control, the device is able to maintain set temperatures for extended periods of time, and can automatically adjust to a different temperature if the set point is changed on the controller. The SPF of our device is the lowest end among reported stretchable skin-mounted heaters. Its simple circuit and program can easily be downscaled to a battery powered printed circuit board (PCB) and microcontroller, giving it potential for point-of-care applications.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method of warming of a patient, comprising:
placing one or more flexible, stretchable heating elements on a patient's skin with a thin electrical insulating layer between the one or more heating elements and the skin;
applying a first voltage to at least one of the one or more flexible, stretchable heating elements;
monitoring a temperature of the one of the one or more flexible, stretchable heating elements while the first voltage is being applied; and
regulating voltage applied to the one of the one or more flexible, stretchable heating elements as the monitored temperature of the one of the one or more flexible, stretchable heating elements approaches a desired temperature.

2. The method of claim 1, wherein placing one or more flexible, stretchable heating elements in close proximity to a patient's skin comprises places a flexible, conformal insulating substrate having a stretchable resistive heating element (RHE) of serpentine-shaped metal ribbons on one side and a stretchable resistance temperature device (RTD) comprised of serpentine-shaped ribbons on another side in close proximity to the patient's skin.

3. The method of claim 2, wherein the stretchable RHE has serpentine-shaped metal ribbons comprised of aluminum.

4. The method of claim 2, wherein the serpentine-shaped ribbons of the RTD are comprised of gold.

5. The method of claim 2, wherein the stretchable RTD is placed closer to the patient's skin than are the one or more stretchable RHEs.

6. The method of claim 2, further comprising an adhesive, wherein the flexible, conformal insulating substrate is at least partially adhered to the patient's skin.

7. The method of claim 2, wherein monitoring the temperature of the one of the one or more flexible, stretchable heating elements while the first voltage is being applied comprises monitoring the temperature of the one of the one or more flexible, stretchable heating elements while the first voltage is being applied using the stretchable RTD.

8. The method of claim 1, wherein regulating the voltage applied to the one of the one or more flexible, stretchable heating elements as the monitored temperature of the one of the one or more flexible, stretchable heating elements approaches the desired temperature comprises regulating the voltage using a regulated power supply in communication with a controller.

9. The method of claim 8, wherein the controller executes proportional-integral-derivative (PID) control software that uses real time temperature feedback to regulate the voltage applied to the one of the one or more flexible, stretchable heating elements by the regulated power supply as the monitored temperature of the one of the one or more flexible, stretchable heating elements approaches the desired temperature.

10. The method of claim 2, wherein at least the one or more RHEs, the flexible, conformal substrate, and the RTDs are formed using a cut and paste method.

11. A system for warming of a patient, comprising:
a regulated power supply;
a controller, wherein the regulated power supply is in communication with and controlled by the controller;
one or more flexible, stretchable resistive heating elements (RHEs), wherein the one or more flexible, stretchable RHEs are connected to the power supply;
one or more temperature measurement devices in communication with the controller through a feedback loop, wherein a first voltage is applied by the regulated power supply to at least one of the one or more flexible, stretchable RHEs, a temperature of the one of the one or more flexible, stretchable RHEs is monitored by the one or more temperature measurement devices in communication with the controller through a feedback loop while the first voltage is being applied, and voltage applied to the one of the one or more flexible, stretchable RHEs is regulated by the regulated power supply in communication with the controller as the monitored temperature of the one of the one or more flexible, stretchable RHEs approaches a desired temperature; and
a thin electrically insulating layer placed over on or both of the one or more flexible, stretchable RHEs and the one or more temperature measurement devices to electrically insulate the one or more flexible, stretchable RHEs and the one or more temperature measurement devices from a patient's skin.

12. The system of claim 11, wherein the one or more flexible, stretchable RHEs are affixed to one side of a flexible, conformal insulating substrate and are comprised of serpentine-shaped metal ribbons and the one or more temperature measurement devices comprise one or more stretchable resistance temperature device (RTD) comprised of serpentine-shaped ribbons that are affixed on an opposite side of the flexible, conformal insulating substrate.

13. The system of claim 12, wherein each of the stretchable RHEs has serpentine-shaped metal ribbons comprised of aluminum.

14. The system of claim 12, wherein the serpentine-shaped ribbons of the one or more RTDs are comprised of gold.

15. The system of claim 12, wherein the one or more stretchable RTDs are placed closer to the patient's skin than are the one or more stretchable RHEs.

16. The system of claim 12, further comprising an adhesive, wherein the adhesive is used to at least partially adhere the flexible, conformal insulating substrate to the patient's skin.

17. The system of claim 12, wherein monitoring the temperature of the one of the one or more flexible, stretchable heating elements while the first voltage is being applied comprises monitoring the temperature of the one of the one or more flexible, stretchable heating elements while the first voltage is being applied using the stretchable RTD.

18. The system of claim 11, wherein the controller executes proportional-integral-derivative (PID) control software that uses real time temperature feedback to regulate the voltage applied to the one of the one or more flexible, stretchable heating elements by the regulated power supply as the monitored temperature of the one of the one or more flexible, stretchable heating elements approaches the desired temperature.

19. The system of claim 12, wherein at least the one or more RHEs, the flexible, conformal substrate, and the one or more RTDs are formed using a cut and paste method.

20. The system of claim 11, wherein the system is used to warm the patient's skin.

21. The system of claim 11, wherein the system is used to warm the patient's body.
